(19) United States
(12) Patent Application Publication
(10) Pub. No.: US 2015/0375576 A1
(43) Pub. Date: Dec. 31, 2015

(54) Tire Based Method and Device for Measuring Running Surface Strength

(71) Applicant: Caterpillar Inc., Peoria, IL (US)

(72) Inventor: Brad L. Holsapple, Metamora, IL (US)

(21) Appl. No.: 14/315,384

(22) Filed: Jun. 26, 2014

(51) Int. Cl. B60C 23/00; G01P 15/00; G01M 17/02

(52) U.S. Cl. CPC B60C 23/002; G01M 17/02; G01P 15/00

(57) ABSTRACT

A method includes measuring a ground condition on which a machine is operated. The method further includes: measuring, by at least one sensor in a machine, at least one of acceleration values and deflection values of a tire rotatably connected to the machine where at least one sensor is in communication with a control device in the machine; determining, by the control device, a ground condition on which the tire is rolling based on the measured at least one of acceleration values and deflection values; determining, by the control device, a desired shape of the tire based on the determined ground condition; and adjusting an inflation pressure of the tire, by a pressure controller in the machine, to obtain the desired shape of the tire.

### TECHNICAL FIELD

The disclosure relates generally to a method for determining a ground condition, and more particularly, to a method for determining a ground condition and adjusting a tire shape based on the determined ground condition.

### BACKGROUND

The operating performance of a machine such as off-road vehicle, dump truck, material handler, etc. is dependent on the contact pressure between the pneumatic tires of the machine and the surface of the ground. The internal pressure of the pneumatic tires affects the contact pressure. To monitor the internal pressure of a pneumatic tire, sometimes, a pressure monitoring sensor is connected to the tire. The sensor moving together with the wheel measures the internal air pressure of the pneumatic tire, and a controller located in the vehicle informs the driver if the internal air pressure is below a specific value. The controller subsequently adjusts the air pressure to the specific value. An example of such a pressure controlling method is disclosed in U.S. Pat. No. 8,532,872 (hereafter “the '872 patent”), entitled “Tire Pressure Adjustment.” The '872 patent is directed towards adjusting an operating tire pressure value to a determined tire pressure value based on tread depth data.

However, to improve the operating performance of a machine, the conditions of the ground on which the machine is operated needs to be considered. For example, when the ground is hard, the pneumatic tires should have high contact pressures with relatively small contact zones for optimum life and rolling resistance. Conversely, when the running surface is soft, the pneumatic tires should have low contact pressure with relatively large contact zones for best traction, flotation and rolling resistance. A constant air pressure in the pneumatic tire does not necessarily provide the optimum operating performance of the machine. The optimum operating conditions of the pneumatic tire need be determined by considering information about the engagement characteristics between the pneumatic tire and the ground. However, the known systems for adjusting the tire pressure based on the tire conditions do not fully address the relationship between the ground condition and the tire.

As a result, there is a need for a system that can determine various ground conditions between the pneumatic tire and the ground and provide an optimum tire condition based on the determined ground conditions.

### SUMMARY

In one aspect, the disclosure is directed to a method, the method including: measuring, by at least one sensor in a machine, at least one of acceleration values and deflection values of a tire rotatably connected to the machine where at least one sensor is in communication with a control device in the machine; determining, by the control device, a ground condition on which the tire is rolling based on the measured at least one of acceleration values and deflection values; determining, by the control device, a desired shape of the tire based on the determined ground condition; and adjusting an inflation pressure of the tire, by a pressure controller in the machine, to obtain the desired shape of the tire.

In another aspect, the disclosure is directed to a machine, the machine including: a sensor to periodically measure at least one of acceleration values and deflection values of a tire in the machine wherein the sensor is attached to the tire; a control device communicatively connected to the sensor, where the control device is configured to determine: a ground condition on which the tire is rolling based on the at least one of acceleration values and deflection values; and a desired shape of the tire based on the determined ground condition; and a pressure controller operatively connected to the tire where the pressure controller is configured to adjust an inflation pressure of the tire to obtain the desired shape of the tire.

In still another aspect, the disclosure is directed to a machine, the machine including: means for periodically measuring at least one of acceleration values and deflection values of a tire of the machine; means for determining conditions wherein the conditions include: an operating shape of the tire; a ground condition based on the at least one of acceleration values and deflection values; and a desired shape of the tire based on the determined ground condition; and means for adjusting an inflation pressure of the tire to obtain the desired shape of the tire.

### BRIEF DESCRIPTION OF THE DRAWINGS

FIG. 1 depicts an illustrative, but nonlimiting example of a machine according to one aspect of the disclosure.

FIG. 2 illustrates a measurement system in accordance with the disclosure.

FIG. 3 illustrates a longitudinal view of an exemplary pneumatic tire in a wheel equipped with a sensor.

FIG. 4 illustrates a cross sectional view of the pneumatic tire and the wheel including a supporting rim.

FIG. 5 is an example showing the deformation of a tire on a rigid surface.

FIG. 6 is a comparison of the results when a tire was tested on a rigid surface and on soft soil.

FIG. 7 shows the acceleration data obtained on a rigid surface.

FIG. 8 shows the acceleration data obtained on soft soil.

FIG. 9 shows a comparison of the radial acceleration data obtained on the rigid surface and on the soft soil.

FIG. 10 shows the deflection data on the rigid surface.

FIG. 11 shows the deflection data on the soft soil.

FIG. 12 shows is a comparison of the deflection data when a tire was tested on a rigid surface and on soft soil.

FIG. 13 is an exemplary diagram of steps to determine an operating ground condition according to the disclosure.

FIG. 14 is another exemplary diagram of steps to adjust a tire shape according to the disclosure.

### DETAILED DESCRIPTION

The particular values and configurations discussed in these non-limiting examples can be varied and are cited merely to illustrate at least one aspect and are not intended to limit the scope thereof.

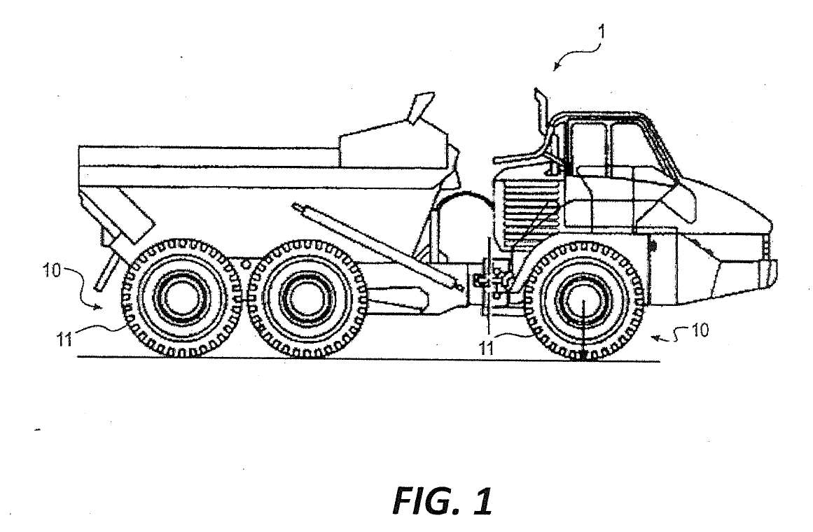

Referring to the drawing, and initially to FIG. 1, an illustrative, but nonlimiting example of a machine 1 is a load-hauling machine, as is shown with wheels 10 and tires 11 in contact with the ground. An illustrative, but nonlimiting, example of wheels 10 includes tires 11. Although a load-hauling machine 1 is disclosed, the disclosure may be applicable to virtually any type of machine that moves through the rotation of wheels 10.

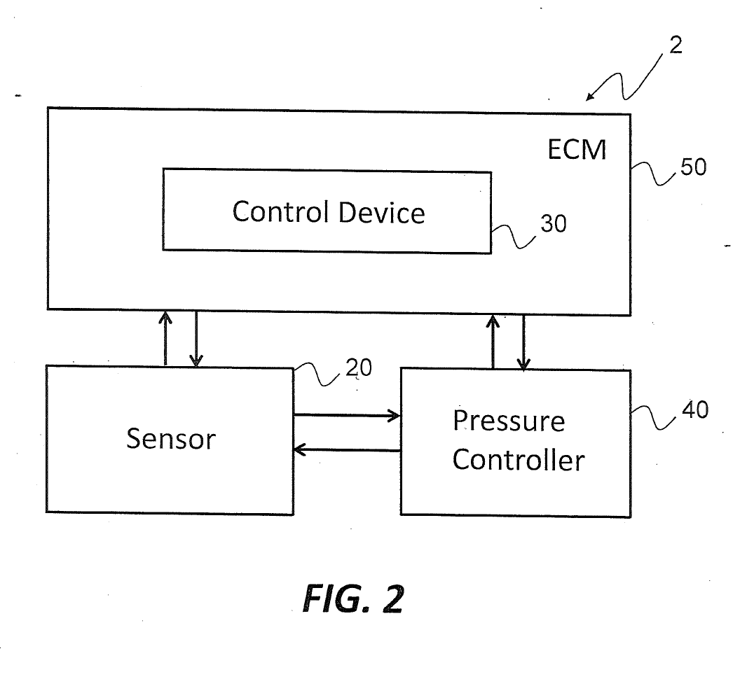

FIG. 2 illustrates a ground measurement system 2 in accordance with the disclosed aspects. The machine 1 may be equipped with the ground measurement system 2. The system 2 may include at least one sensor 20 and a control device 30. The sensor 20 may be attached to a tire 11 in FIG. 1 to measure operating conditions of the tire 11. The sensor 20 may be communicatively connected to the control device 30. The control device 30 may be employed to determine at least one of a ground condition, an operating shape of the tire 11 and a desired shape of the tire 11 for the determined ground condition. Optionally, the control device 30 may be integrated in an Electronic Control Module (ECM) 50 of the machine 1. The control device 30 may be communicatively connected to the pressure controller 40 in the machine 1. In one aspect, the pressure controller 40 may be operatively connected to the tire 11. The pressure controller 40 may regulate an inflation pressure of tire 11 to obtain the desired shape of the tire 11.

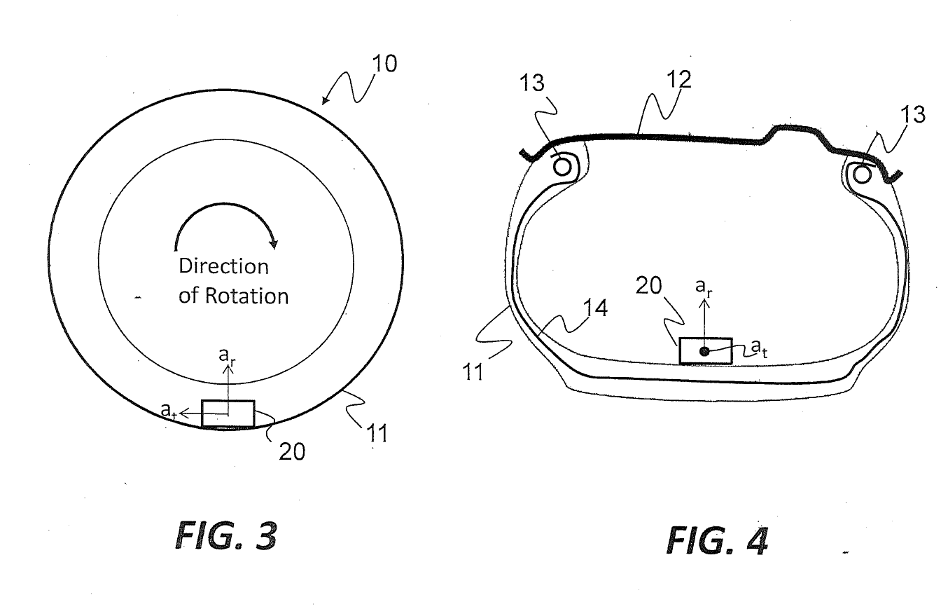

FIG. 3 illustrates a longitudinal view of an exemplary tire 11 equipped with a sensor 20. The sensor 20 may be attached to the tire 11 of the wheel 10. The sensor 20 may be capable of measuring acceleration and/or deflection values of the tire 11 as the machine 1 moves.

FIG. 4 illustrates a cross sectional view of the wheel 10 including a supporting rim 12. The tire 11 of the wheel 10 may include one or more of beads 13. The beads 13 may be made of wound high-tensile steel and may be round, square or semi-rectangular in shape. The beads 13 may keep the tire 11 on the wheel 10 and add to sidewall stiffness. The beads 13 may be received in shoulders of the rim 12. The tire 11 may further include one or more carcasses 14. The carcass 14 may be formed by layers of rubber-coated fabric plies which run radially from bead 13 to bead 13. The carcass 14 may provide the tire 11 with strength in the sidewall area. The tire 11 may have an airtight construction, so that the interior of the tire 11 can be supplied with compressed air by the pressure controller 40.

In one aspect, a sensor 20 may be placed on the inner side of the running surface of the tire 11 so that the sensor 20 can measure acceleration and/or deflection values of the tire 11 during a full revolution from 0° to 360°. In some aspects, a plurality of sensors 20 may be placed on various locations of the inner side of the running surface of the tire 11 so that each of the sensors 20 can measure acceleration and/or deflection values. Optionally, the control device 30 may be placed on the inner side of the running surface of the tire 11 together with the sensor 20.

The sensor 20 may be capable of measuring a plurality of acceleration values of the tire 11 in various directions. For example, in a radial direction, an acceleration of a tire 11 may be obtained by:

acceleration=ω²R Equation 1.

where ω is an instant angular velocity of a rotating tire, R is a radius of the tire 11. The Equation 1 may represent a general form of radial acceleration wherein the tire is not being deformed on the running surface without considering the gravity effects on a tire 11.

The sensor 20 may measure acceleration values in the tangential and/or radial directions. The tangential and/or radial directions may be determined with respect to the rotating sensor 20. The sensor 20 may measure an acceleration value, aₜ, in the tangential direction, and an acceleration value, aᵣ, in the radial direction with respect to the location of the rotating sensor 20 as shown in FIGS. 3 and 4.

Stress at the contact zone between the tire 11 and the ground may vary with an inflation pressure of the tire 11, a normal load on the tire 11, soil and tire deformation/distortion, a size of soil-tire contact zone, and the like. If the ground is soft and the sum of inflation pressure and the pressure produced by the stiffness of the carcass 14 are sufficiently large, the tire 11 may remain more substantially round like a rigid wheel. On the other hand, if the terrain is firm, a portion of the circumference of the tire 11 may be deformed or flattened.

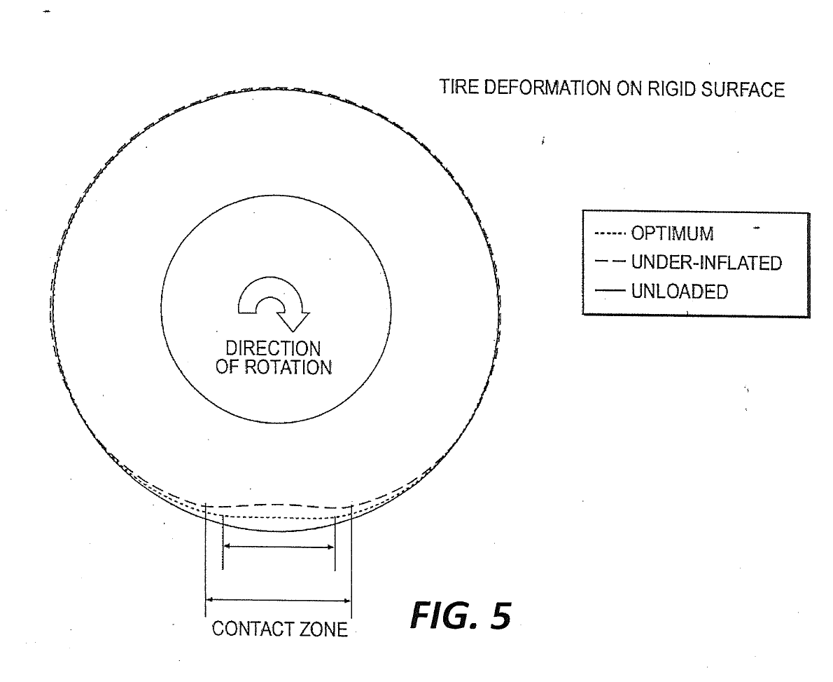

FIG. 5 is an example showing the deformation of a tire 11 on a rigid surface. As shown in FIG. 5, on a rigid surface, the contact zone of the tire may represent the deformation of a tire. The deformation of the tire 11 may vary with applied load and/or inflation pressures. FIG. 5 shows a tire in free rolling under an unloaded condition, a tire in an optimum condition, and a tire in an under-inflated condition. As a function of vertical load and/or inflation pressure, the contact zone may be approximated by a rectangle, an ellipse, or a torus section. On a rigid surface, from these shapes, an overall shape, a vertical load, and an inflation pressure of a tire can be approximated.

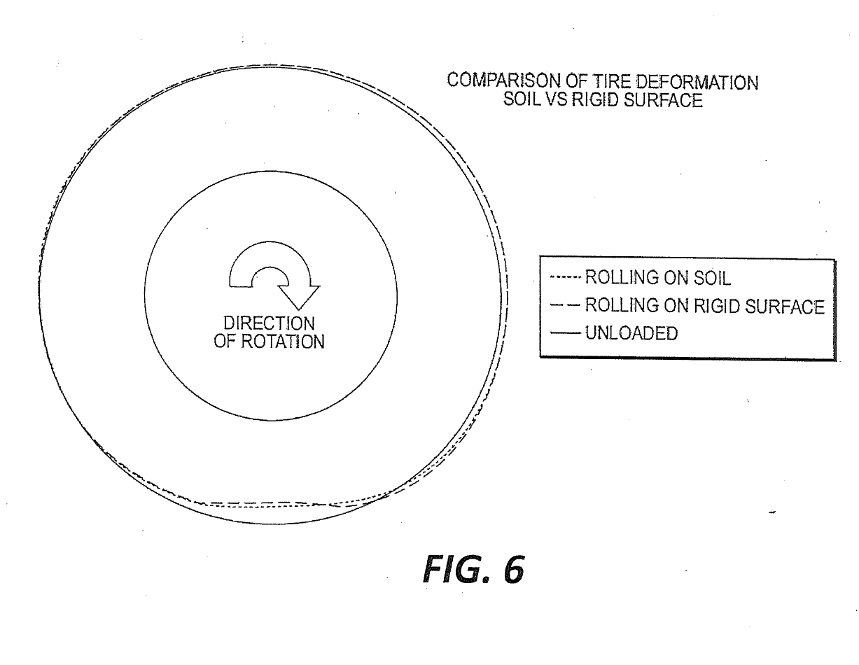

FIG. 6 is a comparison of the results when a tire was tested on a rigid surface and on soft soil. FIG. 6 shows a tire in free rolling under an unloaded condition, a tire in rolling on a rigid surface, and a tire in rolling on soft soil. While the applied load may limit the stresses in the center portion of the contact zone, soil properties may impose another limitation to the rise and fall of the stresses along the tire perimeter. The limits imposed on the interface stresses by the properties of soil may complicate the relationship between the load and the shape of a tire 11. For example, as shown in FIG. 6, even under the same inflation pressure, the deformation of a tire 11 can vary depending on the contact ground condition. Without considering the ground condition, adjusting the inflation pressure of the tire 11 simply in response to the tire deformation may not necessarily improve the performance of a machine 1 in the given ground condition. To maximize the fuel efficiency, traction, and mobility of a machine 1 together with the life of a tire 11, the ground condition needs to be determined. A desired shape and corresponding inflation pressure of the tire 11 may be determined as a function of the ground condition.

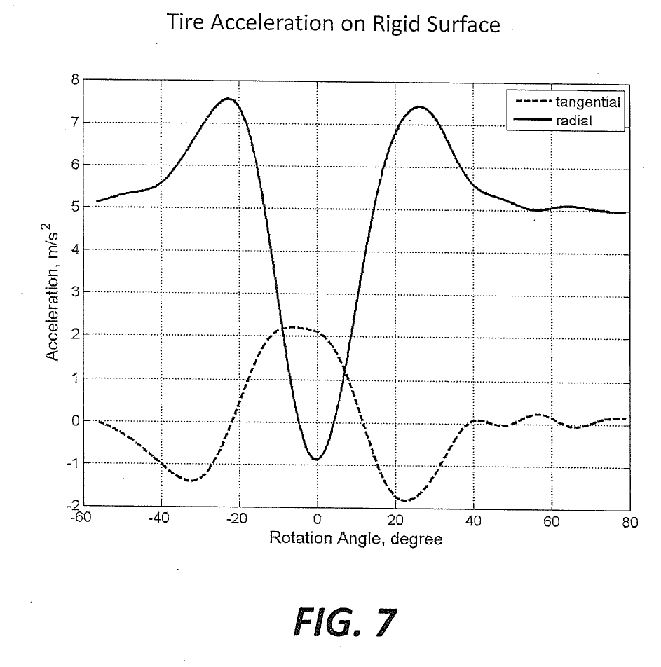

FIG. 7 shows the acceleration values obtained on a rigid surface in the tangential direction and the radial direction. The acceleration values measured in the radial direction and/or the tangential direction may provide information about the tire deformation during rotation of the tire 11. In one aspect, the acceleration values measured in both the radial direction and the tangential direction may provide three-dimensional information of the deformation of the tire 11.

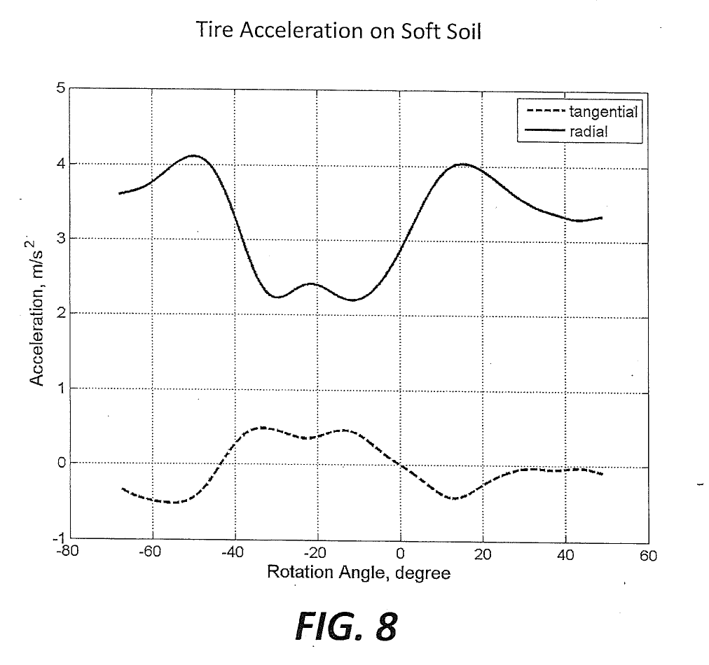

FIG. 8 shows acceleration data obtained from the machine 1 operated on soft soil. The tire 11 in FIG. 8 had the same initial condition as one on the rigid ground in FIG. 7. The sensor 20 placed on the inner side of the running surface of the tire 11 has measured the acceleration values. The acceleration values were measured in both the radial direction and the tangential direction.

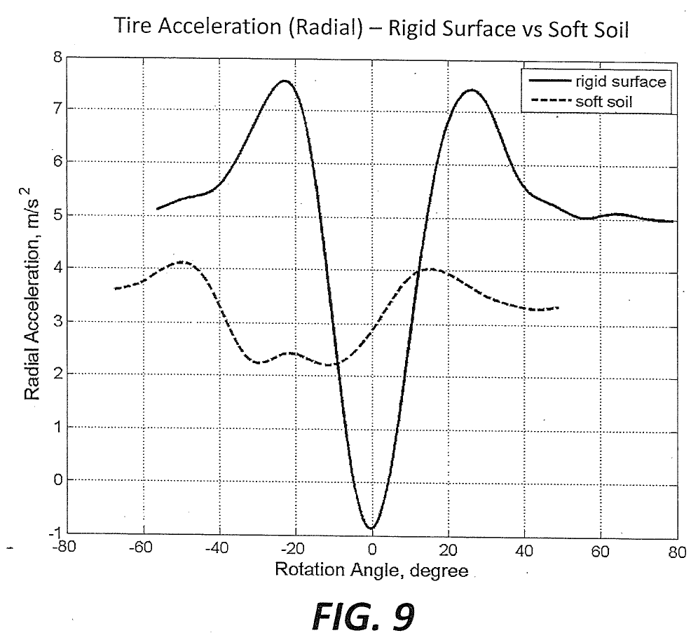

FIG. 9 shows a comparison of the radial acceleration data obtained on the rigid surface and on the soft soil. Comparing the acceleration values obtained on the soft soil with those obtained on the rigid surface shows noticeable differences. The differences in acceleration value resulted from the differences in ground condition.

As the sensor 20 measures the acceleration value of the tire 11, the sensor 20 may send the data to the control device 30 as shown in FIG. 2. The control device 30 may be communicatively connected to the sensor 20. The control device 30 may analyze the acceleration data obtained from the sensor 20 to determine the ground condition. In one aspect, in analyzing the acceleration data, the gravity effect may be removed as shown in FIGS. 7-9. The acceleration values vary with the location of the sensor 20 with respect to the ground as the sensor 20 rotates. To determine the ground condition from the measured acceleration values, the acceleration data may be analyzed in a following form.

$$Surface property = f ( {a}_{max} , {a}_{min} , ( {a}_{max} - {a}_{min} ) , \frac{Δ a}{Δθ} ) , \qquad Equation 2$$

where aₘₐₓ is the maximum value, aₘᵢₙ is the minimum value, (aₘₐₓ−aₘᵢₙ) is the difference between the maximum and the minimum values,

$$\frac{Δα}{Δθ}$$

is an incremental change of the acceleration with respect to an incremental change of angular position during a full rotation of the tire.

The control device 30 may determine the ground condition based on at least one of aₘₐₓ, aₘᵢₙ, (aₘₐₓ−aₘᵢₙ) and,

$$\frac{Δα}{Δθ}$$

obtained throughout a full revolution of the tire 11. As shown in FIGS. 7-9, the differences in acceleration data in aₘₐₓ, aₘᵢₙ, (aₘₐₓ−aₘᵢₙ) and,

$$\frac{Δα}{Δθ}$$

may represent the differences in ground condition. In one aspect, the values of aₘₐₓ, aₘᵢₙ, (aₘₐₓ−aₘᵢₙ) and,

$$\frac{Δα}{Δθ}$$

may be evaluated in a tangential direction and/or a radial direction.

Optionally, the control device 30 may evaluate the deflection data of the tire 11. The deflection of the tire 11 may be defined as the difference between unloaded and loaded section heights, and the percentage deflection may be defined as the percentile ratio of the deflection to the section heights. In one aspect, the control device 30 may obtain the deflection values from the measured acceleration data. In some aspects, the sensor 20 may be capable of measuring the deflection values and provide them to the control device 30.

The deflection values vary with the location of the sensor 20 with respect to the ground as the sensor 20 rotates. To determine the ground condition from the measured deflection values, the deflection data may be analyzed in a following form.

$$Surface property = f ( {d}_{max} , \frac{Δ d}{Δ θ} , max \frac{Δ d}{Δ θ} , Δ θ r ) \qquad Equation 3$$

Where, during a full revolution of the tire 11, dₘₐₓ is the maximum value,

$$\frac{Δ d}{Δθ}$$

is an incremental change of the deflection with respect to an incremental change of angular position during a full revolution of the tire,

$$max \frac{Δ d}{Δ θ}$$

is the maximum value of the incremental change, and Δθr is the rotational distance when

$$\frac{Δ d}{Δθ}$$

is not zero during the full revolution of the tire.

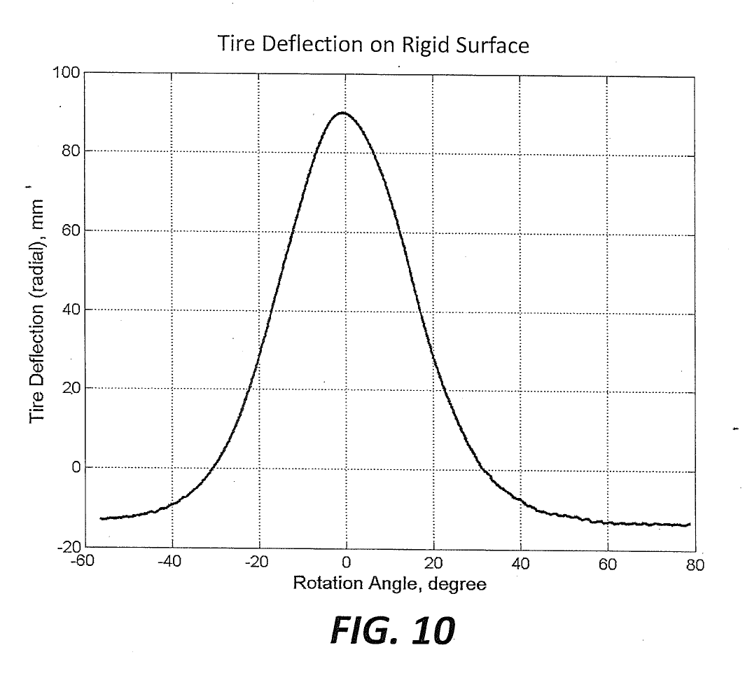

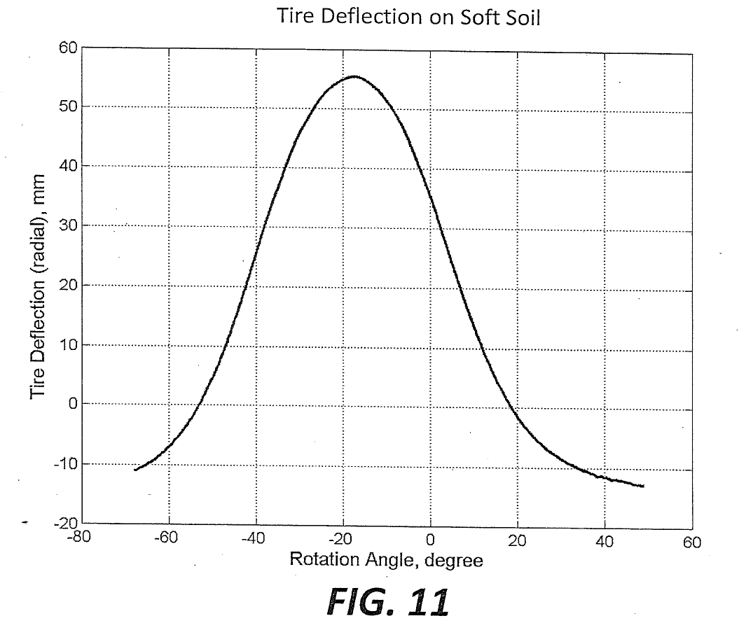

Referring to FIG. 10, FIG. 10 shows the deflection data on a rigid surface. The deflection value increases as the sensor enters the contact zone. On a rigid surface, the peak of the deflection value may form at the center of the contact zone. The deflection value decreases as the sensor exits the contact zone. On a soft surface as shown in FIG. 11, however, the peak of the deflection value does not necessarily form at the center of the contact zone. The width which can be estimated by the Δ∂ and the height of the peak may vary depending on the ground condition.

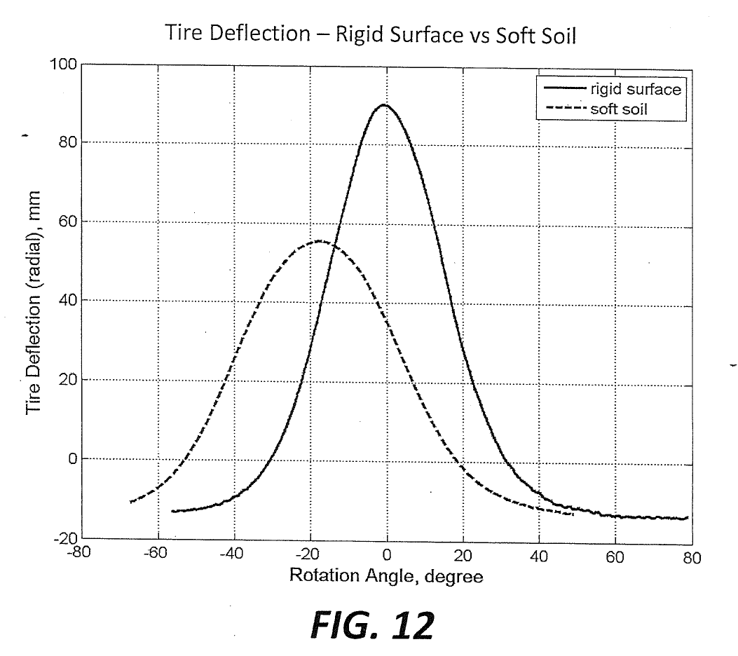

FIG. 12 shows a comparison of the deflection data obtained on the rigid surface and on the soft soil. Comparing the deflection values obtained on the soft soil with those obtained on the rigid surface shows noticeable differences. The differences in deflection value resulted from the differences in ground condition. Evaluating the width and height of the deflection peak in the contact zone may provide information on the ground condition.

The control device 30 may determine an operating shape of the tire 11. In one aspect, the operating shape of the tire 11 may be determined based on the acceleration data and/or the deflection data. In various aspects, a sensor such as a displacement measurement sensor, a laser scanning sensor or the like may be employed to provide information on the operating shape of the tire 11.

The control device 30 may determine the ground condition based on the acceleration values measured with the sensor 20. In one aspect, the determination may be made with the acceleration data measured in the radial direction. In some aspects, the determination may be made by a combination of acceleration values measured in the tangential and the radial direction.

The ground condition may be determined by comparing the measured acceleration values with a set of pre-determined acceleration values for each of a plurality of pre-determined ground conditions. At least one of aₘₐₓ, aₘᵢₙ, (aₘₐₓ−aₘᵢₙ) and,

$$\frac{Δ α}{Δ θ}$$

may be employed as a parameter for the determination. If the values of at least one of aₘₐₓ, aₘᵢₙ, (aₘₐₓ−aₘᵢₙ) and,

$$\frac{Δ α}{Δ θ}$$

fall into a threshold range with respect to the pre-determined values of a specific ground condition, the specific ground condition may be selected. In one aspect, all of aₘₐₓ, aₘᵢₙ, (aₘₐₓ−aₘᵢₙ) and,

$$\frac{Δα}{Δ θ}$$

may be employed as parameters for the determination. When the values of each of aₘₐₓ, aₘᵢₙ, (aₘₐₓ−aₘᵢₙ) and,

$$\frac{Δα}{Δ θ}$$

fall into a threshold range with respect to the pre-determined values of a specific ground condition, the specific ground condition may be elected.

Alternatively, the ground condition may be evaluated with the deflection values. In one aspect, the ground condition may be evaluated by comparing the obtained deflection values with a set of pre-determined deflection values for each of a plurality of pre-determined ground conditions. If the obtained deflection values fall into a threshold range with respect to the pre-determined values for a selected specific ground condition, the specific ground condition may be elected. In one aspect, the deflection values may be obtained from the acceleration values. In some aspects, the deflection values may be directly measured from the sensor 20 and/or an additional sensor. In another aspect, the ground condition may be determined based on the deflection values of the tire 11 together with the acceleration values of the tire 11.

Optionally, the ground condition may be determined by comparing the measured deflection values with a set of pre-determined acceleration values for each of a plurality of pre-determined ground conditions. At least one of

$${d}_{max} , \frac{Δ d}{Δ θ} , max \frac{Δ d}{Δ θ}$$

and Δθr may be employed as a parameter for the determination. If the values of at least one of

$${d}_{max} , \frac{Δ d}{Δ θ} , max \frac{Δ d}{Δ θ}$$

and Δθr fall into a threshold range with respect to the pre-determined values of a specific ground condition, the specific ground condition may be selected. In one aspect, all of

$${d}_{max} , \frac{Δ d}{Δ θ} , max \frac{Δ d}{Δ θ}$$

and Δθr may be employed as parameters for the determination. When the values of each of

$${d}_{max} , \frac{Δ d}{Δθ} , max \frac{Δ d}{Δθ}$$

and Δθr tall into a threshold range with respect to the pre-determined values of a specific ground condition, the specific ground condition may be elected.

Once the ground condition is determined, the control device 30 may determine a desired tire shape associated with the determined ground condition. In one aspect, the desired tire shape may be set to a pre-determined tire shape associated with the specific ground condition. The control device 30 may be communicatively connected to the pressure controller 40 in the machine 1. The pressure controller 40 may detect an inflation pressure of tire 11 via a pressure sensor (not shown for clarity) mounted on the wheel 10, automatically or selectively inflating or deflating the tire 11, depending on the determined ground condition. If the operating tire shape does not correspond to the desired tire shape associated with the determined ground condition, the control device 30 may communicate with the pressure controller 40 to adjust the tire pressure until the desired tire shape can be obtained.

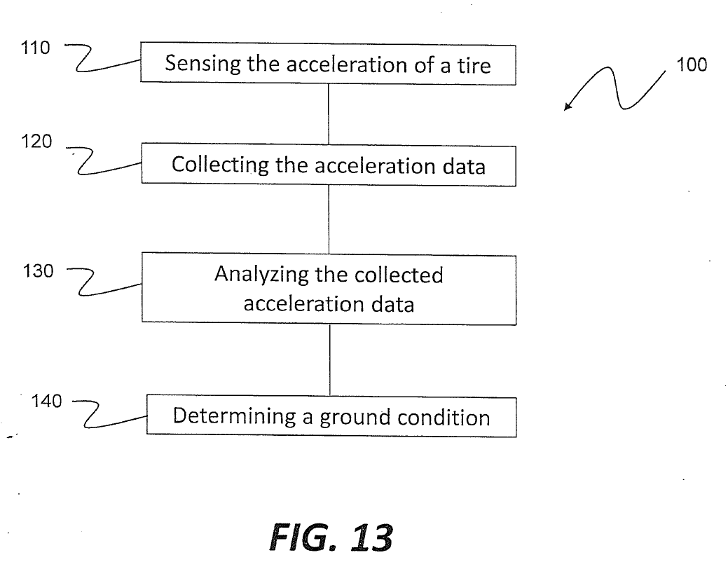

FIG. 13 is an exemplary diagram of steps to determine a ground condition according to the disclosure. In detail, FIG. 13 shows process steps 100 including a step 110 of sensing the acceleration of a tire in the machine, a step 120 of collecting the acceleration data, a step 130 of analyzing the collected acceleration data, and a step 140 of determining a ground condition.

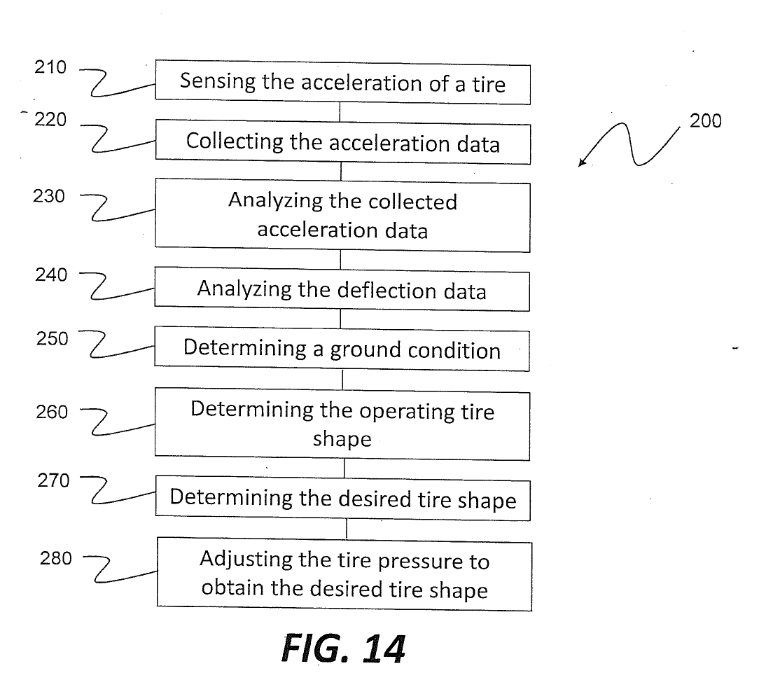

FIG. 14 is another exemplary diagram of steps to adjust a tire shape according to the disclosure. FIG. 14 shows process steps 200 including a step 210 of sensing the acceleration of a tire in the machine, a step 220 of collecting the acceleration data, a step 230 of analyzing the collected acceleration data, a step 240 of analyzing the deflection data, a step 250 of determining a ground condition based on the analyzed acceleration data and deflection data, a step 260 of determining the operating tire shape, a step 270 of determining a desired tire shape based on the determined ground condition and a step 280 of adjusting the tire pressure to obtain the desired tire shape. In one aspect, the steps 200 may be carried out periodically. In some aspects, the steps 200 may be carried out at a command of the machine operator.

### INDUSTRIAL APPLICABILITY

The disclosure may be applicable to any ground measurement system 2 in a machine 1 where detection of a ground condition on which the machine 1 is operated is desired. The machine control system 2 may have a sensor 20 attached to a tire 11 of the machine 1, which is further communicatively connected to a control device 30 that determines, in real-time, a ground condition on which the machine 1 is being operated and determines a desired tire shape of the wheel 10 associated with the determined ground condition.

The sensor 20 may include an acceleration sensor. The acceleration sensor may be a piezoelectric surface mounted type acceleration sensor. The acceleration sensor may include a MEMS (micro electro mechanical systems).

The control device 30 may include any appropriate type of general purpose microprocessor, digital signal processor, microcontroller, dedicated hardware, or the like. The control device 30 may further include or be connected to the random access memory (RAM), the read-only memory (ROM), the storage device, the network interface and the like. The control device 30 may execute sequences of computer program instructions to perform various processes. The computer program instructions may be loaded into the RAM for execution by the processor from the ROM, from a communication channel (wired or wireless), from the storage device and/or the like. The storage device may include any appropriate type of storage provided to store any type of information that the control device may need to perform the processing.

Random access memory (RAM) may store various digital files including the values sensed by the sensor 20. The RAM can be any suitable computer-readable medium. Examples of RAM include, but are not limited to, dynamic random access memory (DRAM), static random access memory (SRAM), ferroelectric random access memory (FRAM), resistive random access memory (RRAM), and diode memory among others. The RAM may provide the sensed values to the processor so that the processor can determine the ground property or type based on the values. The RAM can also store the determined ground condition.

The read-only memory (ROM) may store various digital files. Examples of ROM include, but are not limited to, programmable read-only memory (PROM), erasable programmable read-only memory (EPROM), electrically erasable programmable read-only memory (EEPROM), which includes electrically alterable read-only memory (EAROM) and flash memory, and optical storage, such as CD-ROMs. The RAM and/or ROM may store the algorithm the processor uses to calculate the ground property and type.

The processor may process the values sensed by the sensor 20 that may be stored in the RAM to determine the ground condition using the algorithm stored in the ROM or RAM. The processor may compare the sensed values to the database to determine the ground condition. Once the processor determines the ground condition, the processor may further determine a desired tire shape associated with the ground condition. The processor may send a signal to the pressure controller 40 so that the pressure controller 40 can control the inflation pressure of the tire to obtain the desired tire shape. Examples of processors include computing devices and/or dedicated hardware as defined herein, but are not limited to, one or more central processing units and microprocessors.

The control device 30 may be part of an Engine Control Module (ECM) 50. The ECM 50 may receive information about the operation of the tire 11 through a plurality of sensors. The ECM 50 may use the information from the plurality of sensors to determine the operating conditions of the machine. The ECM 50 may control or dictate the parameters by which the machine operates. These ECM 50 controls may be implemented through software instructions. The ECM 50 may be configured to receive signals from various sensors in the machine, such as a mass air flow sensor, a temperature sensor, a Hall effect sensor, a pressure sensor, a driveshaft torque sensor, a vehicle speed sensor, a displacement measurement sensor, a slope sensor, a grade sensor and an engine speed sensor.

The pressure controller 40 may be operatively connected to the tire 11. In one aspect, an integrated air compressor in the pressure controller 40 may control an air flow to the tire 11 when the operating tire shape is not the desired tire shape, and regulate the inflation pressure of the tire 11. In some aspects, a pressure sensor separate from the acceleration sensor may be attached to the tire 11 so that the inflation pressure of the tire 11 can be communicated to the control device 30 and/or the pressure controller 40.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method, comprising:
measuring, by at least one sensor in a machine, at least one of acceleration values and deflection values of a tire rotatably connected to the machine, wherein the at least one sensor is in communication with a control device in the machine;
determining, by the control device, a ground condition on which the tire is rolling based on the measured the at least one of acceleration values and deflection values;
determining, by the control device, a desired shape of the tire based on the determined ground condition; and
adjusting an inflation pressure of the tire, by a pressure controller in the machine, to obtain the desired shape of the tire.

2. The method according to claim 1, further comprising:
measuring, by the at least one sensor, acceleration values of the tire in a tangential direction.

3. The method according to claim 2, further comprising:
determining, by the control device, the ground condition based on the acceleration values in the tangential direction.

4. The method according to claim 1, further comprising:
measuring, by the at least one sensor, acceleration values in a radial direction.

5. The method according to claim 4, further comprising:
determining, by the control device, the ground condition based on the acceleration values in the radial direction.

6. The method according to claim 1, further comprising:
determining, by the control device, a three dimensional operating tire shape.

7. The method according to claim 1, further comprising:
periodically measuring, by the at least one sensor, the acceleration values of the tire.

8. The method according to claim 1, further comprising:
measuring, by a deflection sensor, deflection values of the tire.

9. The method according to claim 8, further comprising:
determining, by the control device, at least one of
$${d}_{max} , \frac{Δ d}{Δθ} , max \frac{Δ d}{Δθ}$$
and Δθr of deflection values obtained in a full revolution of the tire,
wherein dₘₐₓ is a maximum value,
$$\frac{Δ d}{Δθ}$$
is an incremental change of the deflection with respect to an incremental change of angular position during the full revolution of the tire,
$$max \frac{Δ d}{Δθ}$$
is a maximum value of the incremental change, and Δθr is a rotational distance when
$$\frac{Δ d}{Δθ}$$
is not zero during the full revolution of the tire.

10. The method according to claim 1, further comprising
determining, by the control device, at least one of aₘₐₓ, aₘᵢₙ, (aₘₐₓ−aₘᵢₙ) and,
$$\frac{Δ a}{Δθ}$$
of acceleration values obtained in a full revolution of the tire,
wherein aₘₐₓ is a maximum acceleration value, aₘᵢₙ is a minimum acceleration value, (aₘₐₓ−aₘᵢₙ) is a difference between the aₘₐₓ and the aₘᵢₙ, and
$$\frac{Δ a}{Δθ}$$
is an incremental change or me acceleration with respect to an incremental change of angular position.

11. A machine, comprising:
a sensor to periodically measure at least one of acceleration values and deflection values of a tire in the machine wherein the sensor is attached to the tire;
a control device communicatively connected to the sensor, wherein the control device is configured to determine:
a ground condition on which the tire is rolling based on the at least one of acceleration values and deflection values; and
a desired shape of the tire based on the determined ground condition; and
a pressure controller operatively connected to the tire wherein the pressure controller is configured to adjust an inflation pressure of the tire to obtain the desired shape of the tire.

12. The machine according to claim 11, wherein the sensor is configured to measure acceleration values of the tire in a tangential direction.

13. The machine according to claim 11, wherein the sensor is configured to measure acceleration values in a radial direction.

14. The machine according to claim 11, wherein the control device is configured to determine a three dimensional shape of the tire.

15. The machine according to claim 11, further comprising a deflection sensor to directly measure deflection values of the tire.

16. The machine according to claim 15, wherein the control device is configured to determine at least one of
$${d}_{max} , \frac{Δ d}{Δθ} , max \frac{Δ d}{Δθ}$$
and Δθr of deflection values obtained in a full revolution of the tire,
wherein dₘₐₓ is a maximum value,
$$\frac{Δ d}{Δθ}$$
is an incremental change of the deflection with respect to an incremental change of angular position during the full revolution of the tire,
$$\frac{Δ a}{Δθ}$$
is a maximum value of the incremental change, and Δθr is a rotational distance when
$$max \frac{Δ d}{Δθ}$$
is not zero during the full revolution of the tire.

17. The machine according to claim 11, wherein the control device is configured to determine at least one of aₘₐₓ, aₘᵢₙ, (aₘₐₓ−aₘᵢₙ) and,
$$\frac{Δ d}{Δθ}$$
of the acceleration values obtained in a given amount of time,
wherein aₘₐₓ is a maximum acceleration value, aₘᵢₙ is a minimum acceleration value, (aₘₐₓ−aₘᵢₙ) is a difference between the aₘₐₓ and the aₘᵢₙ, and
$$\frac{Δ a}{Δθ}$$
is an incremental change of the acceleration with respect to an incremental change of angular position.

18. The machine according to claim 11, wherein the machine comprises at least one of an off-road vehicle, a dump truck, a material handler, and a load-hauling machine.

19. A machine, comprising
means for periodically measuring at least one of acceleration values and deflection values of a tire of the machine;
means for determining conditions wherein the conditions comprise:
an operating shape of the tire;
a ground condition based on the at least one of acceleration values and deflection values of a tire; and
a desired shape of the tire based on the determined ground condition; and
means for adjusting an inflation pressure of the tire to obtain the desired shape of the tire.

20. The machine according to claim 19, wherein the conditions further comprise at least one of aₘₐₓ, aₘᵢₙ, (aₘₐₓ−aₘᵢₙ) and,
$$\frac{Δ a}{Δθ}$$
of the acceleration values obtained in a given amount of time,
wherein aₘₐₓ is a maximum acceleration value, aₘᵢₙ is a minimum acceleration value, (aₘₐₓ−aₘᵢₙ) is a difference between the aₘₐₓ and the aₘᵢₙ, and
$$\frac{Δ a}{Δθ}$$
is an incremental change of the acceleration with respect to an incremental change of angular position.
